(19) United States
(12) Patent Application Publication
(10) Pub. No.: US 2025/0088503 A1
(43) Pub. Date: Mar. 13, 2025

(54) TWO-FACTOR AUTHENTICATION SYSTEM, TWO-FACTOR AUTHENTICATION METHOD, AND NON-TRANSITORY COMPUTER READABLE MEDIUM

(71) Applicant: Mitsubishi Electric Corporation, Tokyo (JP)

(72) Inventor: Masahiro FUJITA, Tokyo (JP)

(73) Assignee: Mitsubishi Electric Corporation, Tokyo (JP)

(21) Appl. No.: 18/955,039

(22) Filed: Nov. 21, 2024

Related U.S. Application Data
(63) Continuation of application No. PCT/JP2022/028031, filed on Jul. 19, 2022.

(51) Int. Cl. H04L 9/40

(52) U.S. Cl. CPC H04L 63/083

(57) ABSTRACT

A two-factor authentication system (90) includes an additional authentication apparatus (200). The additional authentication apparatus (200) includes an authentication operation determination unit (250). When the number of times of character inputs that a user has inputted a subject password into a password authentication apparatus (100) is not the minimum number of times to input the subject password, the authentication operation determination unit (250) determines whether or not the user has inputted the subject password into the password authentication apparatus (100) based on auxiliary information indicating a work executed by the user to the password authentication apparatus (100) when the user has inputted the subject password, and information acquired by a sensor (201) during a time period when the user has inputted the subject password.

### CROSS REFERENCE TO RELATED APPLICATION

This application is a Continuation of PCT International Application No. PCT/JP2022/028031, filed on Jul. 19, 2022, which is hereby expressly incorporated by reference into the present application.

### TECHNICAL FIELD

The present disclosure relates to a two-factor authentication system, a two-factor authentication method, and a two-factor authentication program.

### BACKGROUND ART

In recent years, the use of two-factor authentication has increased to improve the security of authentication systems. In the two-factor authentication, the first factor of authentication information is transmitted from a user terminal apparatus such as a Personal Computer (PC) to an authentication apparatus. After that, the second factor of the authentication information is transmitted from another data processing device to the authentication apparatus.

When the two-factor authentication is used, even if a malicious unauthorized person is able to steal a password by infecting a password authentication apparatus with malware, the unauthorized person cannot obtain additional authentication information. Therefore, the two-factor authentication can prevent unauthorized access.

However, the problem with conventional two-factor authentication is that a user who performs authentication needs to operate both of a password authentication apparatus and an additional authentication apparatus. That is, the problem with the conventional two-factor authentication is that the burden on the user is higher than with one-factor authentication.

Non-Patent Literature 1 discloses an additional authentication apparatus that executes an additional authentication process when it is determined that a password authentication process has been executed in a password authentication apparatus by a password input operation of a user. With the additional authentication apparatus, it is possible to realize two-factor authentication that can effectively prevent unauthorized access while achieving the same level of convenience as one-factor authentication.

### CITATION LIST

### Non-Patent Literature

Non-Patent Literature 1: Nozaki, Shinnosuke.; Serizawa, Ayumi.; Yoshihira, Mizuho.; Fujita, Masahiro.; Shibata, Yoichi.; Yamanaka, Tadakazu.; Matsuda, Nori.; Ohki, Tetsushi.; and Nishigaki, Masakatsu. “Multi-Observed Multi-Factor Authentication: A Multi Factor Authentication Using Single Credential”, 2022 Symposium on Cryptography and Information Security, 4B2-2.

### SUMMARY OF INVENTION

### Technical Problem

In general, when a user inputs a password, the user inputs characters one at a time. Hereinafter, the work of inputting a single character is referred to as a character input work. In a case where the password “pass” is input, the character input work is performed four times: “a work of inputting a character p”; “a work of inputting a character a”; “a work of inputting a character s”; and “a work of inputting a character s”, as a specific example. Hereinafter, “a work of inputting a character c” is expressed as [c]. Further, the number of times of character input works performed from the start of password input to the completion of password input is referred to as “the number of times of character inputs”. Further, the minimum number of times of character input works required for inputting a password is referred to as “the minimum number of times of character inputs”. When the password is “pass”, the minimum number of times of character inputs is 4, and the character input works corresponding to the minimum number of times of character inputs are [p], [a], [s], and [s], as a specific example.

However, the user may not perform the password input with the minimum number of times of character inputs. The user may erroneously input [w] after executing [p], [a], and [s], as a specific example. After this, the user executes [s] after performing a work of deleting the character w, that is, after inputting the character to be deleted. Hereinafter, the work of deleting a character, that is, the work of inputting a character to be deleted is expressed as [BS]. In the present example, the user performs the character input work six times: [p]; [a]; [w]; [BS]; [s]; and [s], before completing the password input. Here, BS is an abbreviation for backspace.

Non-Patent Literature 1 does not disclose or suggest a configuration and operation in a case where the user does not input a password with the minimum number of times of character inputs. That is, Non-Patent Literature 1 has a problem that two-factor authentication cannot succeed in the case where the user does not input the password with the minimum number of times of character inputs.

The present disclosure aims in two-factor authentication in which the authentication of the first factor is password authentication, to realize a two-factor authentication system with relatively high authentication accuracy even in a situation where the user does not input a password with the minimum number of times of character inputs while achieving the same level of convenience as one-factor authentication.

### Solution to Problem

A two-factor authentication system according to the present disclosure includes:
a password authentication apparatus into which a user inputs a subject password; and
an additional authentication apparatus to monitor the password authentication apparatus using a sensor, wherein
   the additional authentication apparatus includes an authentication operation determination unit, when the number of times of character inputs that the user has inputted the subject password into the password authentication apparatus is not the minimum number of times to input the subject password, to determine whether or not the user has inputted the subject password into the password authentication apparatus based on auxiliary information indicating a work executed by the user to the password authentication apparatus when the user has inputted the subject password, and information acquired by the sensor during a time period when the user has inputted the subject password.

### Advantageous Effects of Invention

According to the present disclosure, an authentication operation determination unit determines whether or not a user has inputted a subject password into a password authentication apparatus, using auxiliary information and sensor information. Here, the processing of the authentication operation determination unit corresponds to the authentication of the second factor. The auxiliary information indicates a work executed by the user on the password authentication apparatus when the user inputs the subject password. Thus, according to the present disclosure, in two-factor authentication in which the authentication of the first factor is password authentication, it is possible to realize a two-factor authentication system with relatively high authentication accuracy even in a situation where the user does not input a password with the minimum number of times of character inputs while achieving the same level of convenience as one-factor authentication.

### BRIEF DESCRIPTION OF DRAWINGS

FIG. 1 is a diagram illustrating a configuration example of a two-factor authentication system 90 according to Embodiment 1.

FIG. 2 is a diagram illustrating a functional configuration example of an authentication apparatus 300 according to Embodiment 1.

FIG. 3 is a diagram illustrating a functional configuration example of a password authentication apparatus 100 according to Embodiment 1.

FIG. 4 is a diagram illustrating a functional configuration example of an additional authentication apparatus 200 according to Embodiment 1.

FIG. 5 is a diagram illustrating a hardware configuration example of a computer 10 according to Embodiment 1.

FIG. 6 is a flowchart illustrating operation of the two-factor authentication system 90 according to Embodiment 1.

FIG. 7 is a flowchart illustrating the operation of the two-factor authentication system 90 according to Embodiment 1.

FIG. 8 is a diagram for explaining an authentication interface according to Embodiment 1.

FIG. 9 is a diagram illustrating a hardware configuration example of the computer 10 according to a modification of Embodiment 1.

FIG. 10 is a diagram illustrating a functional configuration example of the password authentication apparatus 100 according to Embodiment 2.

FIG. 11 is a diagram illustrating a functional configuration example of the additional authentication apparatus 200 according to Embodiment 2.

FIG. 12 is a flowchart illustrating operation of the two-factor authentication system 90 according to Embodiment 2.

FIG. 13 is a diagram illustrating a functional configuration example of the additional authentication apparatus 200 according to a modification of Embodiment 2.

FIG. 14 is a diagram illustrating a configuration example of the two-factor authentication system 90 according to Embodiment 3.

FIG. 15 is a diagram illustrating a functional configuration example of a mediation apparatus 400 according to Embodiment 3.

FIG. 16 is a diagram illustrating a functional configuration example of the authentication apparatus 300 according to Embodiment 3.

FIG. 17 is a flowchart illustrating operation of the two-factor authentication system 90 according to Embodiment 3.

FIG. 18 is a flowchart illustrating the operation of the two-factor authentication system 90 according to Embodiment 3.

### DESCRIPTION OF EMBODIMENTS

In the description and drawings of embodiments, the same elements and corresponding elements are denoted by the same reference sign. The description of elements denoted by the same reference sign will be omitted or simplified as appropriate. Arrows in the drawings mainly indicate flows of data or flows of processing. Further, “unit” may be appropriately interpreted as “circuit”, “step”, “procedure”, “process”, or “circuitry”.

### Embodiment 1

The present embodiment will be described in detail below with reference to the drawings.

### Description of Configuration

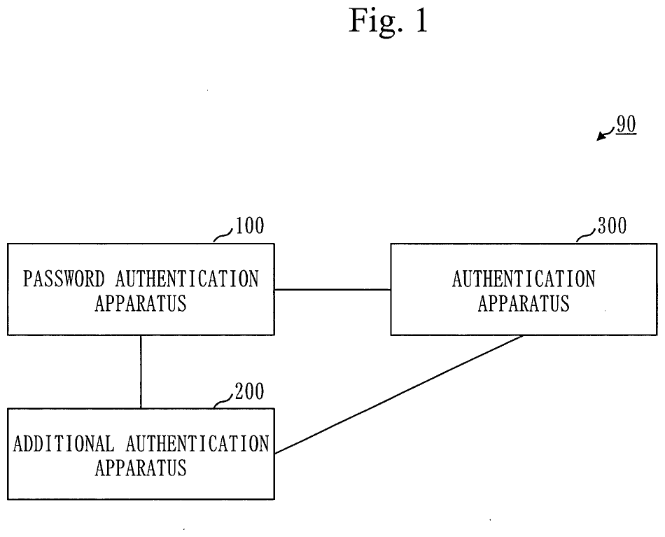

FIG. 1 illustrates a configuration example of a two-factor authentication system 90 according to Embodiment 1. The two-factor authentication system 90 includes a password authentication apparatus 100, an additional authentication apparatus 200, and an authentication apparatus 300, as illustrated in FIG. 1. A plurality of apparatuses that configure the two-factor authentication system 90 may be integrally configured as appropriate.

In many cases, password authentication is used as the authentication of the first factor. Thus, the authentication of the first factor is hereinafter referred to as “password authentication”. Further, a data process for the password authentication is referred to as a “password authentication process”. Further, authentication information used in the password authentication is referred to as a “password”. Further, a user terminal apparatus such as a PC that transmits the password is referred to as a “password authentication apparatus”. Further, an operation in which the user inputs the password into the password authentication apparatus 100 is referred to as a “password input operation”.

Further, the authentication of the second factor is referred to as “additional authentication”. Further, a data process for the additional authentication is referred to as an “additional authentication process”. Further, authentication information used in the second stage or the authentication of the second factor is referred to as “additional authentication information”. The additional authentication information is authentication information that complements password authentication information. Further, a data processing device that transmits the additional authentication information is referred to as an “additional processing device”.

The password authentication apparatus 100 is equivalent to a user terminal apparatus, is an apparatus through which a user inputs a subject password, and executes the password authentication process. The password authentication process is a process of causing the user to input a password into the password authentication apparatus 100 and transmitting to the authentication apparatus 300, the password inputted by the user into the password authentication apparatus 100.

A password is authentication information for the password authentication in the first factor. In the present embodiment, the password is information that is shared in advance between the user and the authentication apparatus 300 in order to perform the password authentication. The password inputted by the user into the password authentication apparatus 100 is hereinafter referred to as a user password.

The password input operation is an operation in which the user inputs a password into the password authentication apparatus 100. Therefore, when the password input operation is executed by the user, it can be determined that the password authentication process has been executed in the password authentication apparatus 100 by the operation of the user.

However, the number of times of character inputs in the password input operation may not be the minimum number required for the number of times of character inputs. Then, the password authentication apparatus 100 records information indicating a procedure of the user when the user executes the password input operation, as auxiliary information. The auxiliary information is information indicating the operation executed by the user on the password authentication apparatus 100 when the user inputs the subject password. The auxiliary information may include information indicating each of a work in which the user has executed an incorrect input and a work in which the user has corrected the incorrect input. A specific example of the auxiliary information is information corresponding to a series of character input operations in the password input operation executed by the user, such as information for displaying “the character input operation has been performed in the order of [p], [a], [w], [BS], [s], and [s]” on a screen. The password authentication apparatus 100 transmits the recorded auxiliary information to the additional authentication apparatus 200.

The additional authentication apparatus 200 is equivalent to a data processing apparatus and includes a sensor 201. The additional authentication apparatus 200 is an apparatus that monitors the password authentication apparatus 100 using the sensor 201. A specific example of the sensor 201 is at least one of a microphone and an angular velocity sensor. When the sensor 201 is the microphone, the additional authentication apparatus 200 monitors the password authentication apparatus 100 using information on audio sound collected by the microphone as sensor information, as a specific example. Further, when the sensor 201 is the angular velocity sensor, the additional authentication apparatus 200 monitors the password authentication apparatus 100 using angular velocity information acquired by the angular velocity sensor as the sensor information.

The additional authentication apparatus 200 determines whether or not the password input operation has been executed by the user, using the auxiliary information independent of the password authentication apparatus 100 and transmitted from the password authentication apparatus 100, based on a monitoring result of the password authentication apparatus 100. That is, the additional authentication apparatus 200 determines whether or not the password input operation has been executed by the operation of the user.

When determining that the password authentication process has been executed in the password authentication apparatus 100 by the password input operation of the user, the additional authentication apparatus 200 executes the additional authentication process. The additional authentication process is a data process that complements the password authentication process. Specifically, the additional authentication apparatus 200 generates, through the additional authentication process, the additional authentication information, and executes a process to transmit the generated additional authentication information to the authentication apparatus 300.

The additional authentication information is information that is shared in advance by the authentication apparatus 300 and the additional authentication apparatus 200 in order to perform the additional authentication. A specific example of the additional authentication information is information that includes information indicating a 128-bit length secret key generated according to Advanced Encryption Standard (AES).

The additional authentication information transmitted by the additional authentication apparatus 200 to the authentication apparatus 300 is hereinafter referred to as user additional authentication information.

When it is determined that the password authentication process has not been executed in the password authentication apparatus 100 by the password input operation of the user, the additional authentication apparatus 200 does not execute the additional authentication process.

The authentication apparatus 300 executes user authentication by two-factor authentication. Specifically, the authentication apparatus 300 compares the user password received from the password authentication apparatus 100 with a registered password. The registered password is a password registered in the authentication apparatus 300 in advance. Further, the authentication apparatus 300 compares the user additional authentication information received from the additional authentication apparatus 200 with registered additional authentication information. The registered additional authentication information is the additional authentication information registered in the authentication apparatus 300 in advance. Then, the authentication apparatus 300 integrates a comparison result between the user password and the registered password and a comparison result between the user additional authentication information and the registered additional authentication information to obtain a final authentication result.

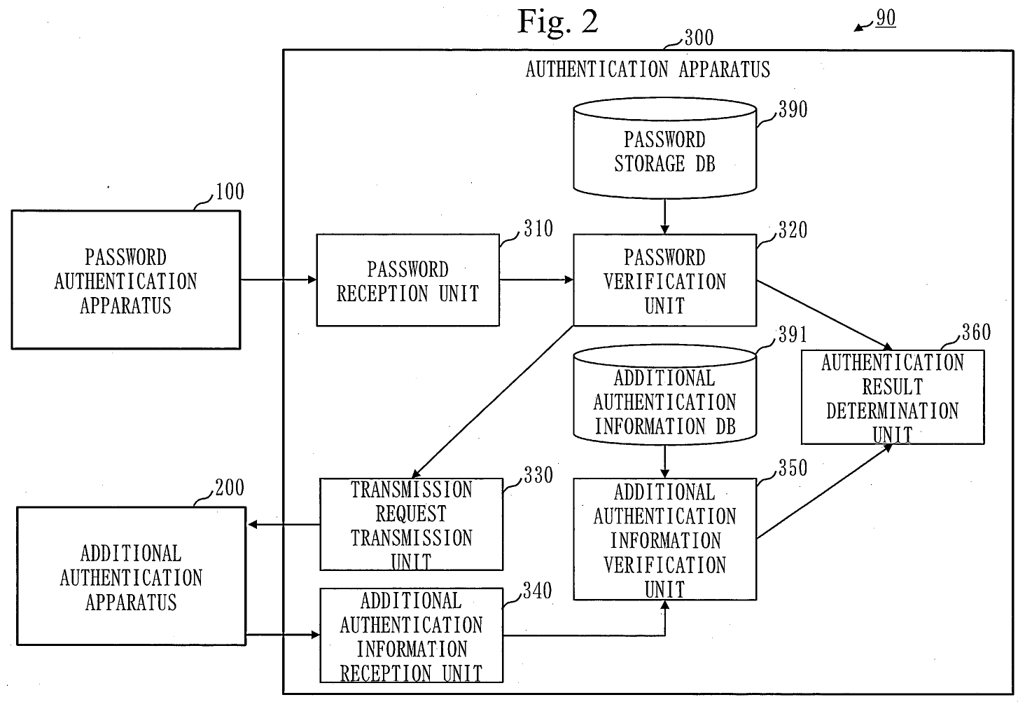

FIG. 2 illustrates a functional configuration example of the authentication apparatus 300. The authentication apparatus 300 includes a password reception unit 310, a password verification unit 320, a transmission request transmission unit 330, an additional authentication information reception unit 340, an additional authentication information verification unit 350, an authentication result determination unit 360, a password storage Database (DB) 390, and an additional authentication information DB 391, as illustrated in FIG. 2.

The password reception unit 310 receives a password from the password authentication apparatus 100.

The password verification unit 320 obtains an authentication result corresponding to the password authentication by verifying whether or not the user password and the registered password are consistent.

The transmission request transmission unit 330 transmits to the additional authentication apparatus 200, data indicating a transmission request for the user additional authentication information (hereinafter also simply referred to as a transmission request).

The additional authentication information reception unit 340 receives the user additional authentication information from the additional authentication apparatus 200.

The additional authentication information verification unit 350 obtains an authentication result corresponding to the additional authentication by comparing the registered additional authentication information with the user additional authentication information.

The authentication result determination unit 360 integrates the authentication result corresponding to the password authentication and the authentication result corresponding to the additional authentication to obtain an authentication result corresponding to the two-factor authentication. That is, the authentication result determination unit 360 determines an authentication result corresponding to the subject password input into the password authentication apparatus 100, based on the subject password input into the password authentication apparatus 100 and a result of determining whether or not the user has inputted the subject password.

The password storage DB 390 stores a registered password. The password storage DB 390 may store a plurality of passwords corresponding to each of a plurality of users.

The additional authentication information DB 391 stores registered additional authentication information. The additional authentication information DB 391 may store a plurality of pieces of additional authentication information corresponding to each of a plurality of users.

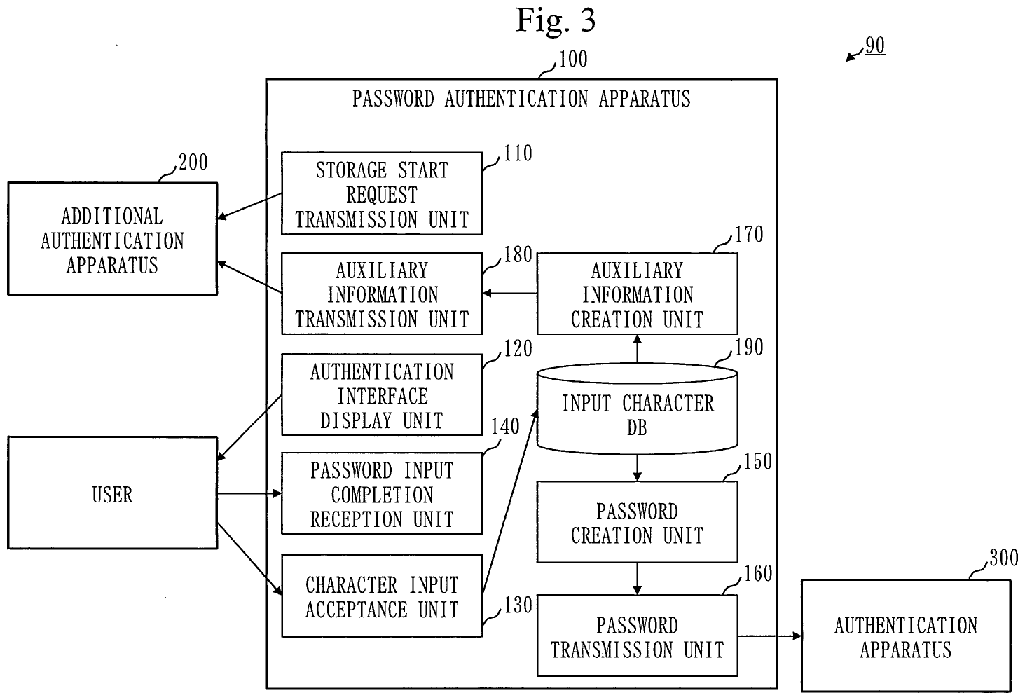

FIG. 3 illustrates a functional configuration example of the password authentication apparatus 100. The password authentication apparatus 100 includes a storage start request transmission unit 110, an authentication interface display unit 120, a character input acceptance unit 130, a password input completion reception unit 140, a password creation unit 150, a password transmission unit 160, an auxiliary information creation unit 170, an auxiliary information transmission unit 180, and an input character DB 190, as illustrated in FIG. 3.

The storage start request transmission unit 110 transmits data indicating a request (hereinafter also referred to as a storage start request) to start storing the sensor information to the additional authentication apparatus 200.

The authentication interface display unit 120 provides an interface for the user to input a user password.

The character input acceptance unit 130 accepts character input from the user, and records the accepted character input in the input character DB 190.

The password input completion reception unit 140 receives from the user, information indicating that the password input has been completed. If an authentication interface has a “send” button, the user notifies the password authentication apparatus 100 that the password input has been completed by pressing the “send” button, as a specific example.

The password creation unit 150 extracts from the input character DB 190, all the characters inputted by the user, and creates a password by combining the extracted characters.

The password transmission unit 160 transmits to the authentication apparatus 300, the password created by the password creation unit 150, as a user password.

The auxiliary information creation unit 170 extracts from the input character DB 190, all the characters inputted by the user, and creates auxiliary information by combining the extracted characters.

The auxiliary information transmission unit 180 transmits to the additional authentication apparatus 200, the auxiliary information created by the auxiliary information creation unit 170.

The input character DB 190 is a DB that records a character inputted by the user.

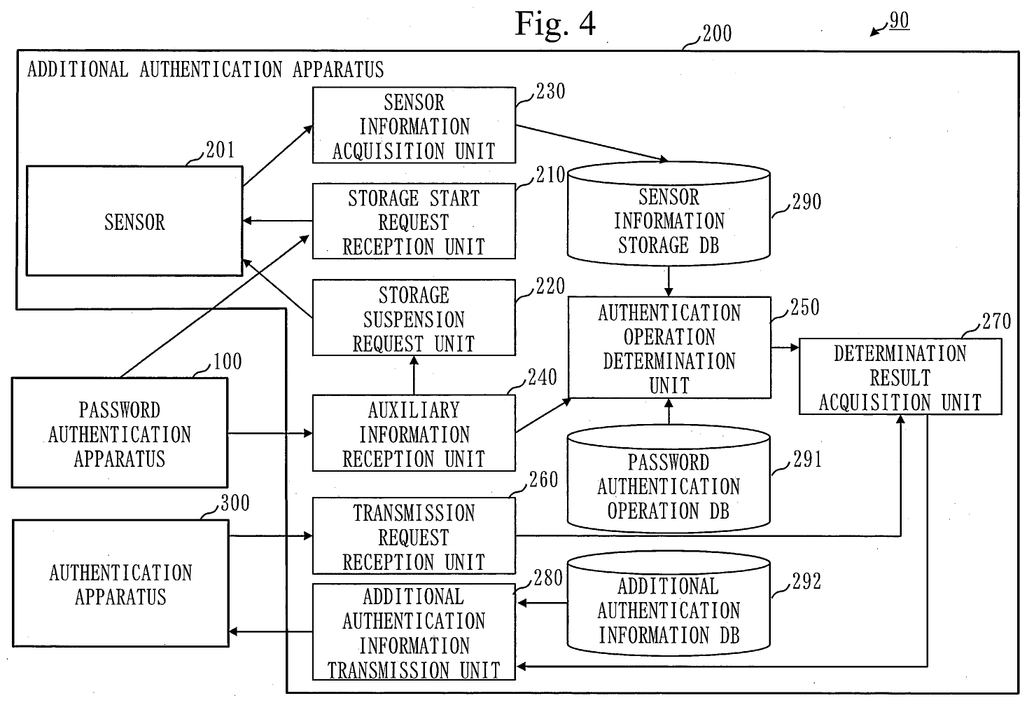

FIG. 4 illustrates a functional configuration example of the additional authentication apparatus 200. The additional authentication apparatus 200 includes the sensor 201, a storage start request reception unit 210, a storage suspension request unit 220, a sensor information acquisition unit 230, an auxiliary information reception unit 240, an authentication operation determination unit 250, a transmission request reception unit 260, a determination result acquisition unit 270, an additional authentication information transmission unit 280, a sensor information storage DB 290, a password authentication operation DB 291, and an additional authentication information DB 292, as illustrated in FIG. 4.

The storage start request reception unit 210 receives from the password authentication apparatus 100, data indicating the storage start request, and instructs the sensor 201 to monitor the password authentication apparatus 100 according to the received data.

The storage suspension request unit 220 instructs the sensor 201 to stop monitoring the password authentication apparatus 100.

The sensor information acquisition unit 230 acquires from the sensor 201, sensor information indicating a monitoring result by the sensor 201, and records the acquired sensor information in the sensor information storage DB 290.

The auxiliary information reception unit 240 receives the auxiliary information from the password authentication apparatus 100, and transmits the received auxiliary information to the authentication operation determination unit 250.

The authentication operation determination unit 250 determines whether or not the password input operation has been executed, using the sensor information extracted from the sensor information storage DB 290, the auxiliary information received from the auxiliary information reception unit 240, and a determination rule extracted from the password authentication operation DB 291. The determination rule is also referred to as a password input operation determination rule. That is, the authentication operation determination unit 250 monitors the password authentication apparatus 100 using the sensor 201, and determines whether or not the password authentication process has been executed by the password input operation of the user based on the result of monitoring the password authentication apparatus 100. The authentication operation determination unit 250 is also referred to as a password authentication operation determination unit.

When the number of times of character inputs in a case where the user inputs the subject password to the password authentication apparatus 100 is not the minimum number of times required for inputting the subject password, the authentication operation determination unit 250 determines whether or not the user has inputted the subject password to the password authentication apparatus 100 based on the auxiliary information and information acquired by the sensor 201 during a time period when the user has inputted the subject password. Here, a process of the authentication operation determination unit 250 is equivalent to the authentication of the second factor. When determining whether or not the user has inputted the subject password into the password authentication apparatus 100, the authentication operation determination unit 250 may use a rule corresponding to a work to be executed when the user inputs the subject password into the password authentication apparatus 100. The rule indicates, as a specific example, a required work, an interval of the work, and the like.

The transmission request reception unit 260 receives data indicating the transmission request from the authentication apparatus 300.

The determination result acquisition unit 270 acquires from the authentication operation determination unit 250, data indicating an authentication operation determination result which is a determination result of the authentication operation determination unit 250. Further, the determination result acquisition unit 270 acquires from the transmission request reception unit 260, the data indicating the transmission request. After that, when transmission of the user additional authentication information is required, the determination result acquisition unit 270 instructs the additional authentication information transmission unit 280 of the transmission of the user additional authentication information.

On the other hand, in at least one of a case where the authentication operation determination unit 250 is unable to determine that the password authentication process has been executed by the password input operation of the user and a case where the transmission request reception unit 260 has not received the data indicating the transmission request from the authentication apparatus 300, the determination result acquisition unit 270 does not instruct the additional authentication information transmission unit 280 of the transmission of the user additional authentication information.

The additional authentication information transmission unit 280 acquires from the additional authentication information DB 292, the user additional authentication information corresponding to the authentication operation determination result according to the instruction of the determination result acquisition unit 270, and transmits the acquired user additional authentication information to the authentication apparatus 300.

The sensor information storage DB 290 is a DB that records sensor information.

The password authentication operation DB 291 is a DB that records a password input operation of the user. When the additional authentication apparatus 200 monitors the password authentication apparatus 100 using the microphone, the password authentication operation DB 291 records an audio sound signal a(t)=[aΔt, a2Δt, a3Δt, . . . , a|a(t)|] at a time when the user inputs a registered password, as a specific example. Here, the audio sound signal a(t) at the time of the password input is information in which sound pressure generated when the user performs the password input operation is sampled and recorded every Δt seconds.

The additional authentication information DB 292 stores additional authentication information of the user.

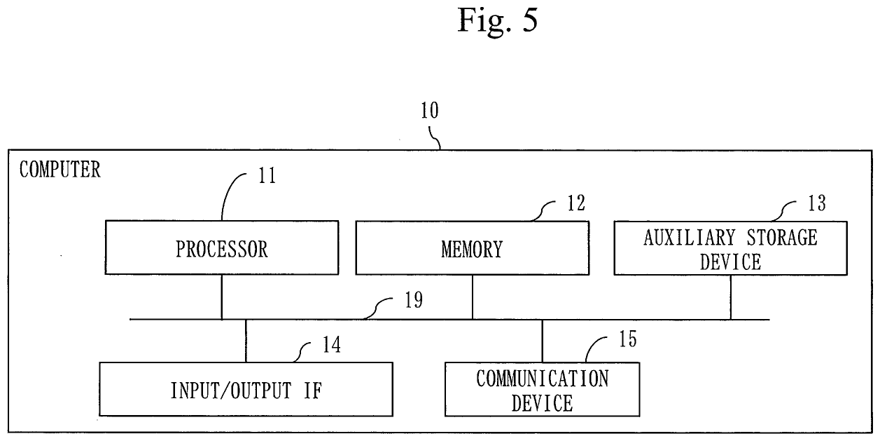

FIG. 5 illustrates a hardware configuration example of a computer 10 according to the present embodiment. Each of the password authentication apparatus 100, the additional authentication apparatus 200, and the authentication apparatus 300 includes of the computer 10. The computer 10 may include of a plurality of computers.

The computer 10 is a computer that includes pieces of hardware such as a processor 11, a memory 12, an auxiliary storage device 13, an input/output Interface (IF) 14, a communication device 15, and the like, as illustrated in the present diagram. These pieces of hardware are connected via signal lines 19 as appropriate.

The processor 11 is an Integrated Circuit (IC) that performs arithmetic processing and controls the hardware included in the computer. A specific example of the processor 11 is a Central Processing Unit (CPU), a Digital Signal Processor (DSP), or a Graphics Processing Unit (GPU).

The computer 10 may include a plurality of processors in place of the processor 11. The plurality of processors share the role of the processor 11.

The memory 12 is typically a volatile storage device. A specific example of the memory 12 is a Random Access Memory (RAM). The memory 12 is also referred to as a main storage device or a main memory. Data stored in the memory 12 is saved in the auxiliary storage device 13 as necessary.

The auxiliary storage device 13 is typically a non-volatile storage device. A specific example of the auxiliary storage device 13 is a Read Only Memory (ROM), a Hard Disk Drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. A specific example of the input/output IF 14 is a Universal Serial Bus (USB) terminal. Specific examples of the input device are a keyboard and a mouse. A specific example of the output device is a display.

The communication device 15 is a receiver and a transmitter. A specific example of the communication device 15 is a communication chip or a Network Interface Card (NIC).

When communicating with another device or the like, each unit of each device may appropriately use the input/output IF 14 and the communication device 15.

The auxiliary storage device 13 stores a two-factor authentication program. The two-factor authentication program is a program that causes the computer to implement a function of each unit included in each device. The two-factor authentication program is loaded into the memory 12 and executed by the processor 11. The function of each unit included in each device is implemented by software.

Data used when the two-factor authentication program is executed, data obtained by executing the two-factor authentication program, and the like are appropriately stored in the storage device. Each unit of the computer 10 uses the storage device in an appropriate manner. The storage device includes at least one of the memory 12, the auxiliary storage device 13, a register in the processor 11, and a cache memory in the processor 11, as a specific example. Note that the term data and the term information may have the same meaning. The storage device may be independent of the computer 10.

Functions of the memory 12 and the auxiliary storage device 13 may be implemented by another storage device.

The two-factor authentication program may be recorded in a computer readable non-volatile recording medium. A specific example of the non-volatile recording medium is an optical disc or a flash memory. The two-factor authentication program may be provided as a program product.

### Description of Operation

An operation procedure of each device that configures the two-factor authentication system 90 is equivalent to a two-factor authentication method. Further, a program that implements operation of each device that configures the two-factor authentication system 90 is equivalent to the two-factor authentication program.

In the following, it is assumed that the additional authentication apparatus 200 is provided with a microphone as the sensor 201. Further, sensor information is an audio sound signal obtained by the microphone. The audio sound signal obtained by the microphone is hereinafter also simply referred to as an audio sound signal.

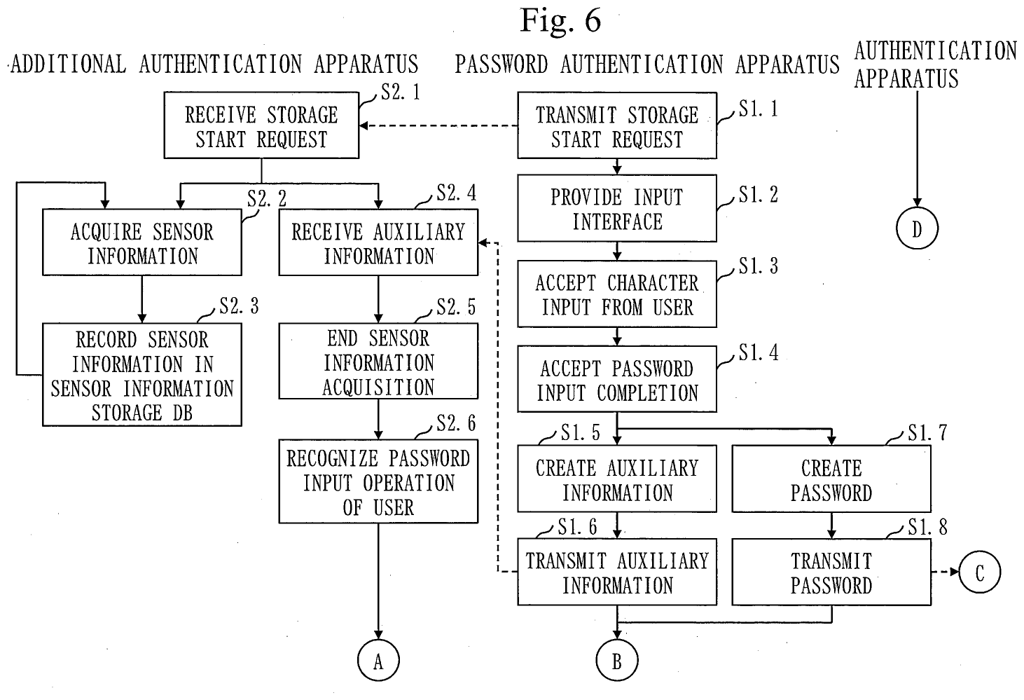

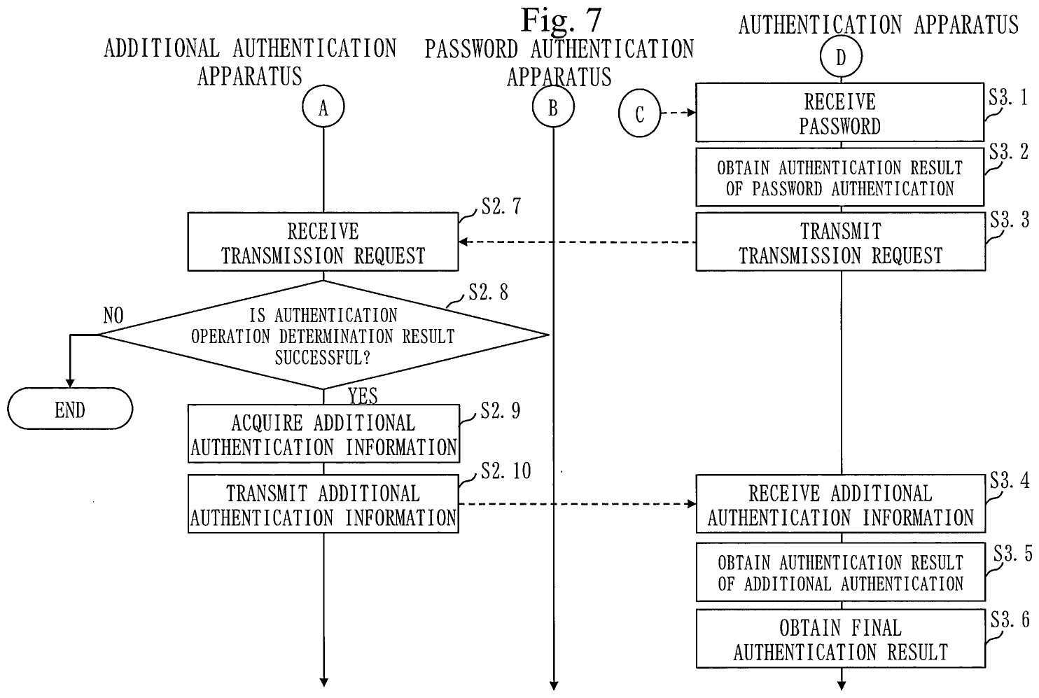

FIGS. 6 and 7 are flowcharts illustrating an operation example of the two-factor authentication system 90. Operation of the two-factor authentication system 90 will be described with reference to FIGS. 6 and 7.

### (Step S1.1)

The storage start request transmission unit 110 transmits data indicating a storage start request to the additional authentication apparatus 200.

### (Step S1.2)

The authentication interface display unit 120 displays an authentication interface to the user.

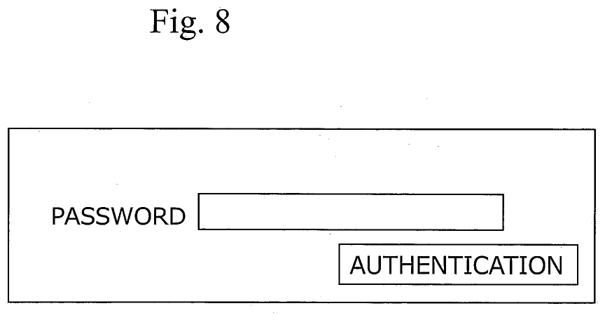

The authentication interface display unit 120 displays the authentication interface such as that illustrated in FIG. 8 as a specific example. In the authentication interface illustrated in FIG. 8, a password input form and an authentication button are provided. The user executes a password input operation on the password input form, that is, inputs a character string that is a password on the password input form. After that, the user notifies the password authentication apparatus 100 that the password input has been completed by pressing the authentication button. In the following, the description relating to the present example will be given as appropriate.

### (Step S1.3)

The character input acceptance unit 130 accepts character input from the user, and records the accepted character input in the input character DB 190.

In the present step, it is assumed that the user has performed [p][a][w][BS][s][s], that is, it is assumed that a character string of p, a, w, BS, s, s has been inputted, and it is assumed that information indicating the character string has been recorded in the input character DB 190, as a specific example. In the following, the description relating to the present example will be given as appropriate.

### (Step S1.4)

The password input completion reception unit 140 accepts from the user, information indicating that the password input has been completed.

Here, the password input completion reception unit 140 accepts information indicating that the user has pressed the “authentication” button on the authentication interface.

### (Step S1.5)

The auxiliary information creation unit 170 creates auxiliary information by referring to information recorded in the input character DB 190.

Here, the auxiliary information creation unit 170 refers to the characters recorded in the input character DB 190, that is, refers to p, a, w, BS, s, s. Further, it is assumed that the auxiliary information creation unit 170 creates auxiliary information indicating where BS has been pressed in the character string, that is, information indicating that “the user has pressed BS at the fourth character” is used as the auxiliary information.

### (Step S1.6)

The auxiliary information transmission unit 180 transmits to the additional authentication apparatus 200, the auxiliary information created by the auxiliary information creation unit 170.

### (Step S1.7)

In parallel with step S1.5, the password creation unit 150 creates a password by referring to the information recorded in the input character DB 190.

Here, the password creation unit 150 refers to the characters recorded in the input character DB 190, that is, refers to p, a, w, BS, s, s. Further, since a character string corresponding to the referred character is “pass”, the password creation unit 150 creates the character string “pass” as the password.

### (Step S1.8)

The password transmission unit 160 transmits to the authentication apparatus 300, the password created by the password creation unit 150.

### (Step S2.1)

The storage start request reception unit 210 receives the data indicating the storage start request, and instructs the sensor 201 to start monitoring the password authentication apparatus 100 according to the received data.

### (Step S2.2)

The sensor information acquisition unit 230 acquires sensor information from the sensor 201.

Here, it is assumed that the sensor information acquisition unit 230 acquires information indicating a value a of one piece of the sound pressure at each Δt which is a sampling interval.

### (Step S2.3)

The sensor information acquisition unit 230 stores the acquired sensor information in the sensor information storage DB 290. Here, it is assumed that the information indicating the value a of the sound pressure acquired by the sensor information acquisition unit 230 is stored unchanged.

Steps S2.2 and S2.3 are repeated a plurality of times until step S2.5 is performed. That is, the information aΔt, a2Δt, a3Δt, . . . is recorded sequentially in the sensor information storage DB 290 until step S2.5 is performed.

### (Step S2.4)

The auxiliary information reception unit 240 receives the auxiliary information from the password authentication apparatus 100, and transmits the received auxiliary information to the authentication operation determination unit 250.

### (Step S2.5)

The storage suspension request unit 220 instructs the sensor 201 to end monitoring the password authentication apparatus 100.

### (Step S2.6)

The authentication operation determination unit 250 recognizes the password input operation of the user.

The authentication operation determination unit 250 acquires the sensor information from the sensor information storage DB 290, acquires the auxiliary information from the auxiliary information reception unit 240, and corrects the acquired sensor information by the acquired auxiliary information. After that, the authentication operation determination unit 250 determines whether or not the user has executed the password input operation by determining whether or not the password input operation corresponding to the corrected sensor information and the password input operation obtained from the password authentication operation DB 291 are consistent.

A specific example of a determination process by the authentication operation determination unit 250 will be given.

Here, in order to simplify the description, it is assumed that a timing at which the user inputs one character and a timing at which the sensor 201 obtains an audio sound are the same. That is, it is assumed that the audio sound signal obtained by the sensor 201 when the password pass is input is a(t)=[a1Δt, a2Δt, a3Δt, a4Δt]. Here, a1Δt indicates the sound pressure obtained by the microphone when the user inputs p, a2×t indicates the sound pressure obtained by the microphone when the user inputs a, and each of a3×t and a4Δt indicates the sound pressure obtained by the microphone when the user inputs s. Hereinafter, the sound pressure generated when a key corresponding to a character c is pressed is expressed as vc. That is, the sound pressure signal obtained by the sensor 201 when the password pass is input is a(t)=[vp, va, vs, vs].

When the password is pass, since pass has four characters, four pieces of sound pressure information vp, va, vs, vs are stored in advance in the password authentication operation DB 291.

Here, the user has executed [p][a][w][BS][s][s] to the password authentication apparatus 100. Therefore, the sensor information acquisition unit 230 acquires the sound pressure information from the microphone in the order of vp, va, vw, vBS, vs, vs, and records the acquired sound pressure information in the sensor information storage DB 290.

Here, when the sound pressure information vp, va, vw, vBS, vs, vs acquired from the microphone is simply compared with the sound pressure information vp, va, vs, vs recorded in the password authentication operation DB 291, it is determined that the user has not executed the password input operation because the two pieces of sound pressure information are not consistent.

However, by using the auxiliary information which is “the user has pressed BS at the fourth character”, it can be seen that the character corresponding to the third sound pressure has been deleted since the fourth sound pressure information among vp, va, vw, vBS, vs, vs corresponds to the sound pressure for delating a character. That is, it can be seen that the third sound pressure and the fourth sound pressure are not necessary when the password is input with the minimum number of times of inputs, that is, the sound pressure information obtained when the password input operation is executed with the minimum number of times of inputs is vp, va, vs, vs. This sound pressure information is consistent with the sound pressure information vp, va, vs, vs recorded in the password authentication operation DB 291. Therefore, the authentication operation determination unit 250 can determine that the user has executed the password input operation.

### (Step S2.7)

The transmission request reception unit 260 receives the data indicating the transmission request from the authentication apparatus 300.

### (Step S2.8)

The determination result acquisition unit 270 determines whether or not the determination result of the authentication operation determination unit 250 indicates a successful state. That is, the determination result acquisition unit 270 determines whether or not the authentication operation determination unit 250 recognizes that the password input operation has been executed by the user.

When the determination result of the authentication operation determination unit 250 indicates the successful state, the additional authentication apparatus 200 proceeds to step S2.9. Otherwise, the additional authentication apparatus 200 ends the process of the present flowchart.

### (Step S2.9)

The additional authentication information transmission unit 280 acquires the user additional authentication information from the additional authentication information DB 292. In the present embodiment, the user additional authentication information is information that includes a 128-bit length secret key generated by AES.

### (Step S2.10)

The additional authentication information transmission unit 280 transmits the acquired user additional authentication information to the authentication apparatus 300.

### (Step S3.1)

The password reception unit 310 receives the user password from the password authentication apparatus 100.

### (Step S3.2)

The password verification unit 320 obtains an authentication result corresponding to the password authentication. Specifically, the password verification unit 320 obtains the password from the password storage DB 390, and determines whether or not the obtained password and the user password are consistent.

When the obtained password and the user password are consistent, the authentication apparatus 300 executes step S3.3.

### (Step S3.3)

The transmission request transmission unit 330 transmits the data indicating the transmission request to the additional authentication apparatus 200.

### (Step S3.4)

The additional authentication information reception unit 340 receives the user additional authentication information from the additional authentication apparatus 200.

### (Step S3.5)

The additional authentication information verification unit 350 obtains an authentication result corresponding to the additional authentication. Specifically, the additional authentication information verification unit 350 acquires the registered additional authentication information from the additional authentication information DB 391, and determines whether or not the acquired registered additional authentication information and the user additional authentication information are consistent.

### (Step S3.6)

The authentication result determination unit 360 obtains a final authentication result by integrating the authentication result corresponding to the password authentication and the authentication result corresponding to the additional authentication.

Specifically, when both of the authentication result corresponding to the password authentication and the authentication result corresponding to the additional authentication indicate successful states, the authentication result determination unit 360 sets the final authentication result to a successful state. Otherwise, the authentication result determination unit 360 sets the final authentication result to a failure state.

### Description of Effects of Embodiment 1

As described above, even if a user dose not input a password with the minimum number of times of character inputs, a two-factor authentication system according to the present embodiment has relatively high authentication accuracy by using auxiliary information.

### Other Configurations

### Modification 1

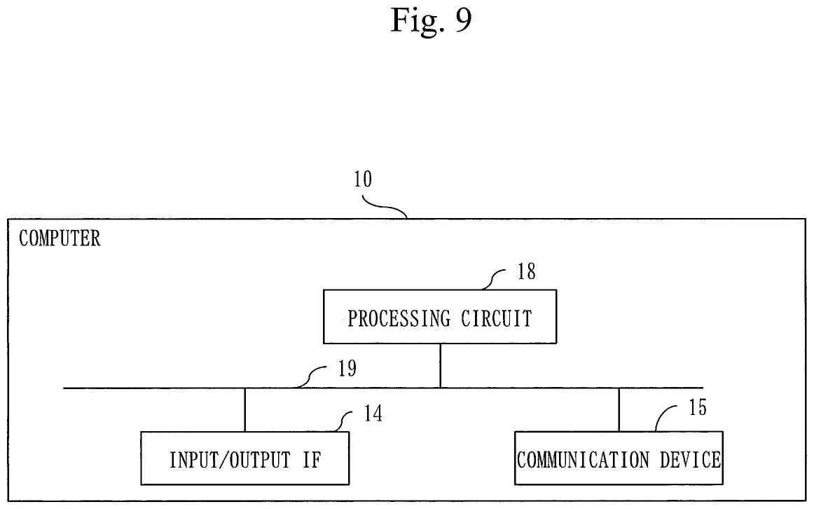

FIG. 9 illustrates a hardware configuration example of the computer 10 according to the present modification.

The computer 10 includes a processing circuit 18 in place of the processor 11, the processor 11 and the memory 12, the processor 11 and the auxiliary storage device 13, or the processor 11, the memory 12, and the auxiliary storage device 13.

The processing circuit 18 is hardware that implements at least a part of each unit included in the computer 10.

The processing circuit 18 may be dedicated hardware, or may be a processor that executes programs stored in the memory 12.

When the processing circuit 18 is the dedicated hardware, a specific example of the processing circuit 18 is a single circuit, a composite circuit, a programmed processor, a parallel-programmed processor, an Application Specific Integrated Circuit (ASIC), a Field Programmable Gate Array (FPGA), or a combination of thereof.

The computer 10 may include a plurality of processing circuits as an alternative to the processing circuit 18. The plurality of processing circuits share the role of the processing circuit 18.

In the computer 10, some functions may be implemented by the dedicated hardware, and the remaining functions may be implemented by software or firmware.

The processing circuit 18 is implemented by, as a specific example, hardware, software, firmware, or a combination of thereof.

The processor 11, the memory 12, the auxiliary storage device 13, and the processing circuit 18 are collectively referred to as “processing circuitry”. That is, the functions of the individual functional components of the individual apparatuses are implemented by the processing circuitry.

The computer 10 according to other embodiments may also have the same configuration as that of the present modification.

### Embodiment 2

Differences from the above described embodiment will be mainly described below with reference to the drawings.

### Description of Configuration

In Embodiment 1, the character input acceptance unit 130 may operate without waiting for operation start of the sensor information acquisition unit 230. That is, before the additional authentication apparatus 200 starts monitoring the password authentication apparatus 100, there may be a case where the execution of the password input operation of the user is started, and there may be a case where the password input operation of the user is completed. In these cases, the additional authentication apparatus 200 fails to determine whether or not the password input operation has been executed by the user.

In Embodiment 2, configurations and operation will be described in which the execution of the password input operation is prevented from being started before the additional authentication apparatus 200 starts monitoring the password authentication apparatus 100.

In the present embodiment, configurations of the password authentication apparatus 100 and the additional authentication apparatus 200 are different from those described in Embodiment 1.

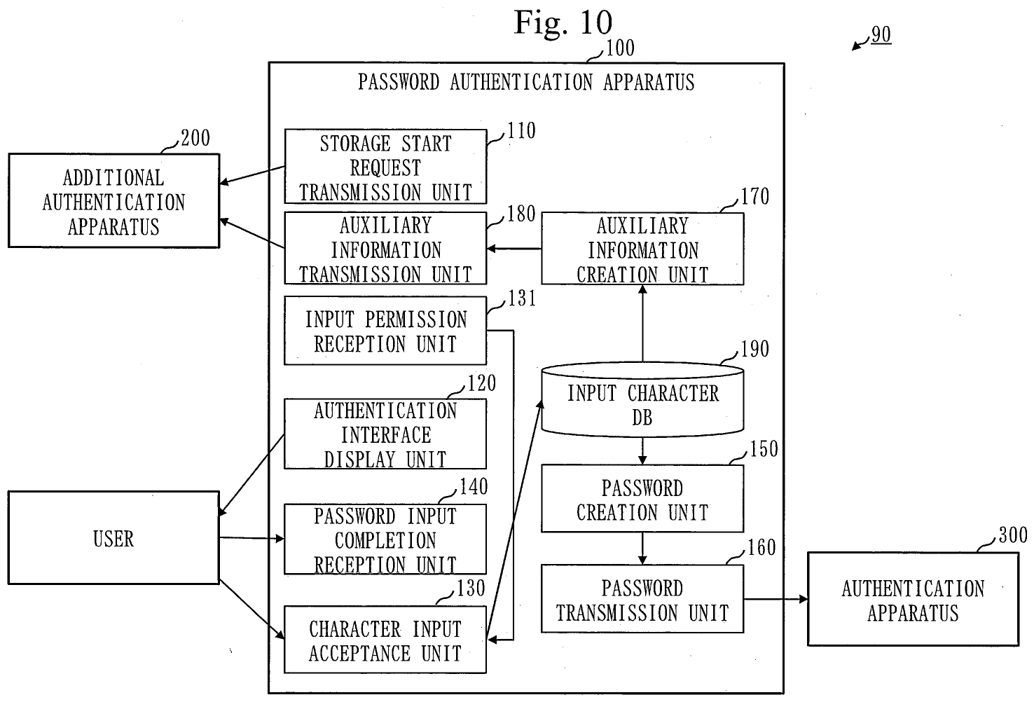

FIG. 10 illustrates a functional configuration example of the password authentication apparatus 100 according to the present embodiment. The password authentication apparatus 100 further includes an input permission reception unit 131, as illustrated in FIG. 10. Differences from Embodiment 1 will be described below.

The input permission reception unit 131 receives from the additional authentication apparatus 200, data indicating character input permission (hereinafter also simply referred to as input permission), and transmits the received data to the character input acceptance unit 130.

The character input acceptance unit 130 accepts character input from the user. However, the character input acceptance unit 130 does not accept the character input from the user until receiving the data indicating the input permission from the input permission reception unit 131. That is, the user cannot input a character into the password authentication apparatus 100 until the character input acceptance unit 130 receives the data indicating the input permission. When receiving input permission information from the additional authentication apparatus 200, the character input acceptance unit 130 permits the user to input the subject password, as a specific example. The input permission information is information indicating that the password input is permitted. The character input acceptance unit 130 records the accepted input character in the input character DB 190.

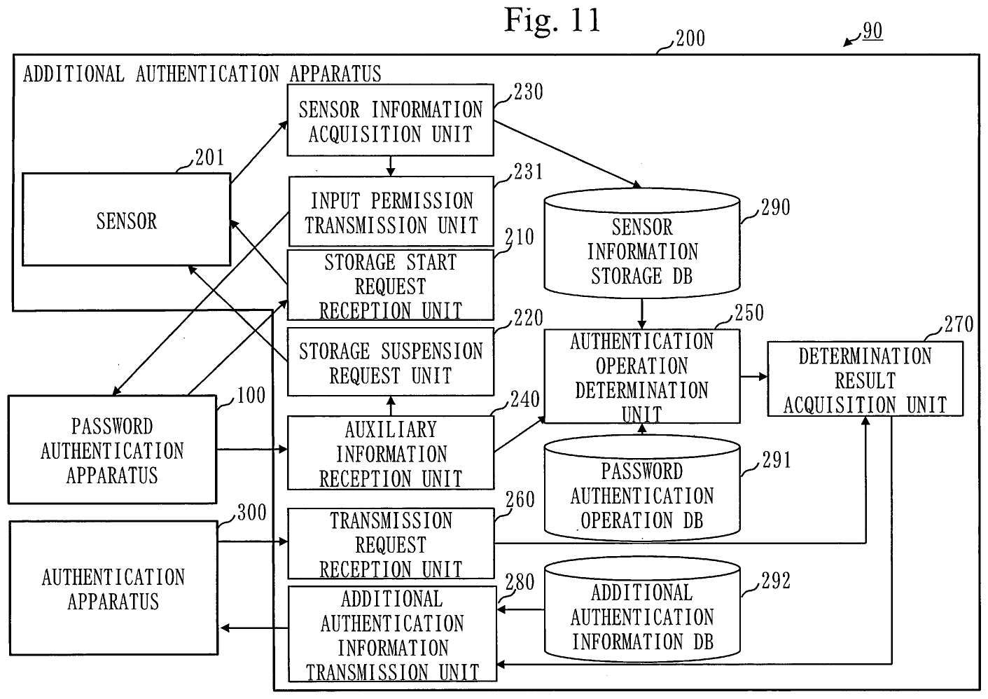

FIG. 11 illustrates a functional configuration example of the additional authentication apparatus 200 according to the present embodiment. The additional authentication apparatus 200 further includes an input permission transmission unit 231, as illustrated in FIG. 11. Differences from Embodiment 1 will be described below.

The sensor information acquisition unit 230 acquires from the sensor 201, sensor information indicating a monitoring result of the sensor 201. Further, when the acquisition of the sensor information starts, the sensor information acquisition unit 230 transmits to the input permission transmission unit 231, the data indicating the input permission.

The input permission transmission unit 231 transmits to the password authentication apparatus 100, the data indicating the input permission according to the data received from the sensor information acquisition unit 230. That is, when the sensor 201 is in operation, the input permission transmission unit 231 transmits the input permission information to the password authentication apparatus 100.

### Description of Operation

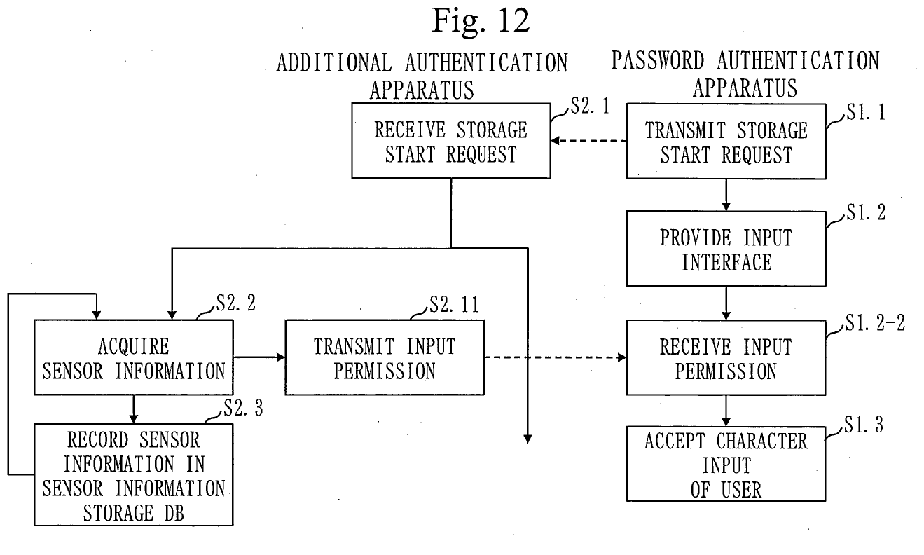

FIG. 12 is a flowchart illustrating an operation example of the additional authentication apparatus 200 and the password authentication apparatus 100 in Embodiment 2. Differences from Embodiment 1 will be described below with reference to FIG. 12.

### (Step S1.1)

The storage start request transmission unit 110 transmits the data indicating the storage start request to the additional authentication apparatus 200.

### (Step S1.2)

The authentication interface display unit 120 displays the authentication interface to the user.

### (Step S1.2-2)

The input permission reception unit 131 receives the data indicating the input permission.

The operation example after this is the same as the operation example after step S1.3 in Embodiment 1.

### (Step S2.1)

The storage start request reception unit 210 receives the data indicating the storage start request, and instructs the sensor 201 to start monitoring the password authentication apparatus 100 according to the received data.

### (Step S2.2)

The sensor information acquisition unit 230 acquires the sensor information from the sensor 201. Further, at the time of the acquisition of the sensor information for the first time, the sensor information acquisition unit 230 instructs the input permission transmission unit 231 to transmit the data indicating the input permission to the password authentication apparatus 100.

### (Step S2.3)

The sensor information acquisition unit 230 stores the acquired sensor information in the sensor information storage DB 290.

### (Step S2.11)

The input permission transmission unit 231 transmits to the password authentication apparatus 100, the data indicating the input permission.

Other operation examples are the same as those in Embodiment 1.

### Description of Effects of Embodiment 2

As described above, according to the present embodiment, a user cannot start password input before the additional authentication apparatus 200 starts monitoring the password authentication apparatus 100. That is, according to the present embodiment, it is possible to prevent the user from starting a password input operation before the additional authentication apparatus 200 starts monitoring the password authentication apparatus 100, and to implement a two-factor authentication system with higher authentication accuracy.

### Configuration of Others

### Modification 2

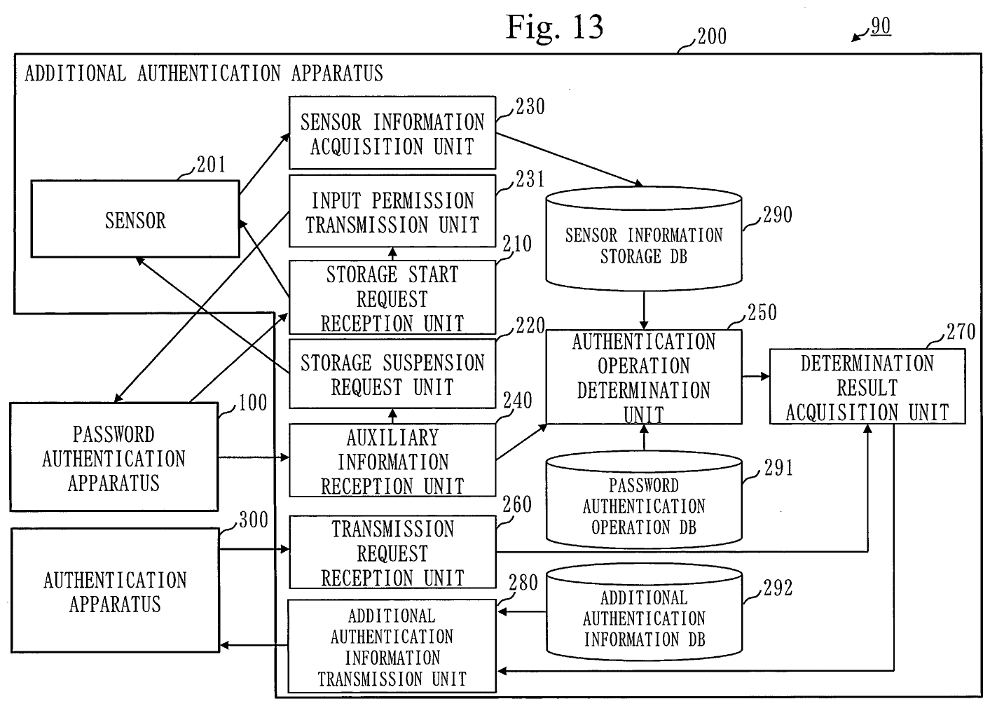

FIG. 13 indicates a functional configuration example of the additional authentication apparatus 200 according to the present modification. As illustrated in FIG. 13, the storage start request reception unit 210 may transmit the data indicating the input permission to the input permission transmission unit 231. That is, the storage start request reception unit 210 may instruct the sensor 201 to start monitoring the password authentication apparatus 100, and may also transmit the data indicating the input permission to the input permission transmission unit 231.

### Embodiment 3

Hereinafter, differences from the embodiments described above will be mainly described with reference to the drawings.

### Description of Configuration

In Embodiment 2, the additional authentication apparatus 200 and the password authentication apparatus 100 communicate directly. However, when the two apparatuses communicate directly, the password authentication apparatus 100 can know that the additional authentication apparatus 200 is in a communicable state in a case where the communication with the additional authentication apparatus 200 is successful, and the password authentication apparatus 100 can know that the additional authentication apparatus 200 is in a non-communicable state in a case where the communication with the additional authentication apparatus 200 fails. That is, Embodiment 2 has a problem relating to privacy in that the password authentication apparatus 100 can know whether or not the additional authentication apparatus 200 is activated.

Then, in order to solve this problem, in Embodiment 3, the additional authentication apparatus 200 and the password authentication apparatus 100 do not communicate directly, but communicate via a mediation apparatus 400.

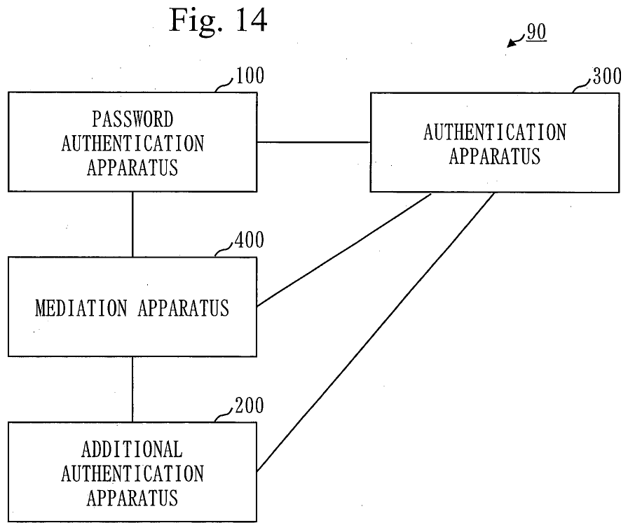

FIG. 14 illustrates a configuration example of the two-factor authentication system 90 according to the present embodiment. The two-factor authentication system 90 further includes the mediation apparatus 400, as illustrated in FIG. 14. In the present embodiment, the additional authentication apparatus 200 and the password authentication apparatus 100 do not communicate directly, but communicate via the mediation apparatus 400.

The mediation apparatus 400 mediates communication between the password authentication apparatus 100 and the additional authentication apparatus 200. It is assumed that the mediation apparatus 400 is always in operation while the two-factor authentication system 90 is activated.

Further, the configuration of the authentication apparatus 300 according to the present embodiment is different from the configuration of the authentication apparatus 300 according to Embodiment 2.

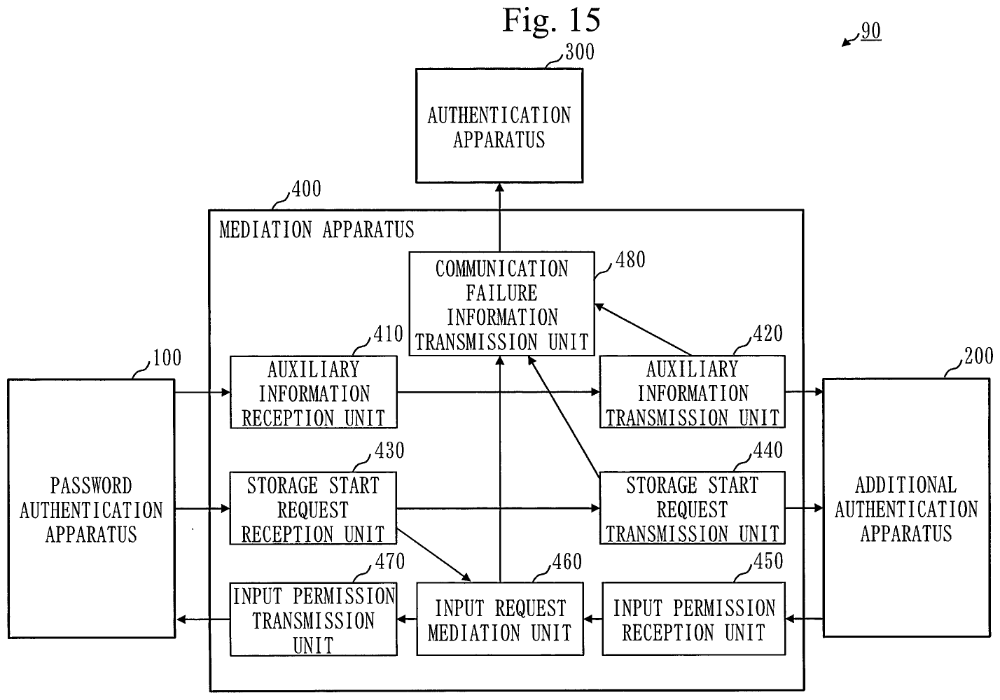

FIG. 15 illustrates a functional configuration example of the mediation apparatus 400. The mediation apparatus 400 includes an auxiliary information reception unit 410, an auxiliary information transmission unit 420, a storage start request reception unit 430, a storage start request transmission unit 440, an input permission reception unit 450, an input request mediation unit 460, an input permission transmission unit 470, and a communication failure information transmission unit 480, as illustrated in FIG. 15.

The auxiliary information reception unit 410 receives the auxiliary information from the password authentication apparatus 100, and transmits the received auxiliary information to the auxiliary information transmission unit 420.

However, when the mediation apparatus 400 fails to communicate with the additional authentication apparatus 200, the auxiliary information reception unit 410 instructs the communication failure information transmission unit 480 to operate.

The auxiliary information transmission unit 420 transmits to the additional authentication apparatus 200, the auxiliary information received from the auxiliary information reception unit 410. That is, the auxiliary information transmission unit 420 transmits to the additional authentication apparatus 200, the auxiliary information received from the password authentication apparatus 100.

The storage start request reception unit 430 receives the data indicating the storage start request from the password authentication apparatus 100, and transmits the received data to the storage start request transmission unit 440. Further, the storage start request reception unit 430 transmits to the input request mediation unit 460, information (hereinafter also referred to as transmitted information) indicating that the data indicating the storage start request has been transmitted to the storage start request transmission unit 440.

The storage start request transmission unit 440 transmits to the additional authentication apparatus 200, the data indicating the storage start request received from the storage start request reception unit 430. However, when the storage start request transmission unit 440 fails to communicate with the additional authentication apparatus 200 at the time of transmitting the data, the storage start request transmission unit 440 instructs the communication failure information transmission unit 480 to operate.

The input permission reception unit 450 receives an input permission signal from the additional authentication apparatus 200, and transmits the received input permission signal to the input request mediation unit 460. When the mediation apparatus 400 fails to communicate with the additional authentication apparatus 200, the input permission reception unit 450 does not operate.

The input request mediation unit 460 receives the transmitted information from the storage start request reception unit 430, and transmits the data indicating the input permission to the input permission transmission unit 470 after k seconds have passed since receiving the transmitted information. Here, k is an arbitrary positive number. k seconds is a specific example of a median time. The time point at which the input request mediation unit 460 transmits the data indicating the input permission to the input permission transmission unit 470 is a transmission determination time point. The transmission determination time point is a time point at which the median time or more has elapsed since the mediation apparatus 400 has received storage start request information from the password authentication apparatus 100. The storage start request information is data indicating that the additional authentication apparatus 200 is instructed to monitor the password authentication apparatus 100.

When the input request mediation unit 460 has not received the data indicating the input permission from the input permission reception unit 450 at the time point k seconds have passed since receiving the transmitted information, the input request mediation unit 460 transmits communication failure information to the communication failure information transmission unit 480. That is, when the input request mediation unit 460 has not received the data indicating the input permission from the input permission reception unit 450 for k seconds, the input request mediation unit 460 instructs the communication failure information transmission unit 480 to operate.

The input permission transmission unit 470 receives the data indicating the input permission from the input request mediation unit 460, and transmits the received data to the password authentication apparatus 100. When the mediation apparatus 400 has received the input permission information from the additional authentication apparatus 200 at the time of transmission determination, the input permission transmission unit 470 transmits the input permission information to the password authentication apparatus 100, as a specific example.

When the communication failure information transmission unit 480 is instructed to operate by at least one of the auxiliary information transmission unit 420, the storage start request transmission unit 440, and the input request mediation unit 460, the communication failure information transmission unit 480 transmits communication failure information to the authentication apparatus 300.

The storage start request transmission unit 110 according to the present embodiment transmits to the mediation apparatus 400, the storage start request information which is data indicating the storage start request.

When receiving the input permission information from the mediation apparatus 400, the character input acceptance unit 130 according to the present embodiment permits the user to input the subject password, as a specific example.

The auxiliary information transmission unit 180 according to the present embodiment transmits to the mediation apparatus 400, the auxiliary information created by the auxiliary information creation unit 170.

The storage start request reception unit 210 according to the present embodiment receives the data indicating the storage start request from the mediation apparatus 400.

The auxiliary information reception unit 240 according to the present embodiment receives the auxiliary information from the mediation apparatus 400.

The input permission transmission unit 231 according to the present embodiment transmits the input permission information to the mediation apparatus 400 when the sensor 201 is activated.

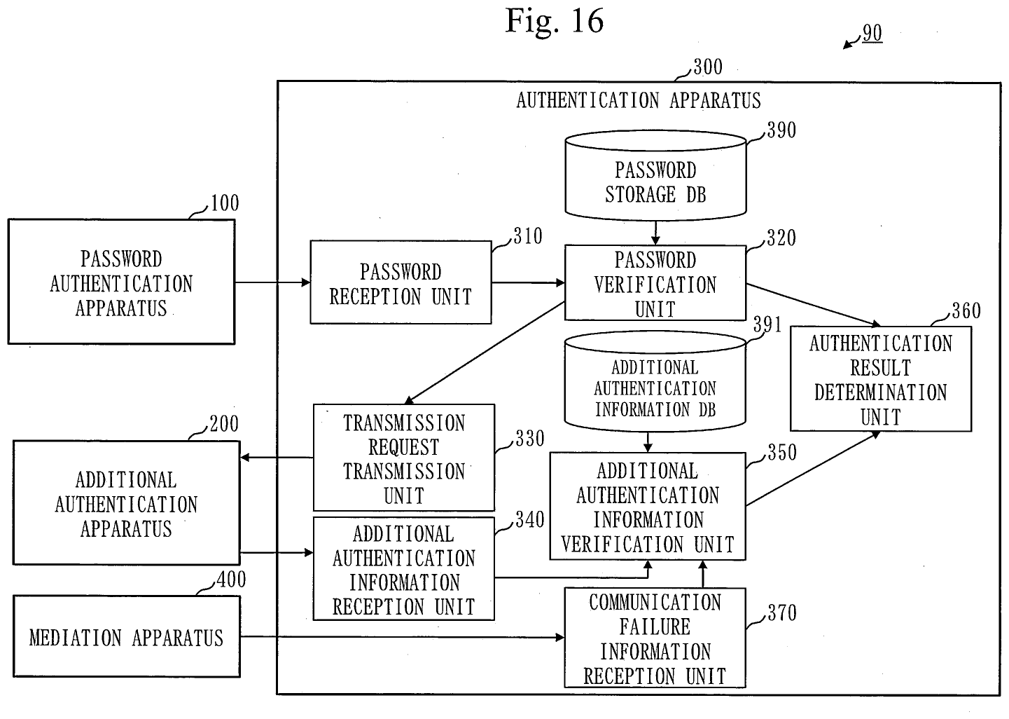

FIG. 16 illustrates a functional configuration example of the authentication apparatus 300 according to the present embodiment. The authentication apparatus 300 further includes a communication failure information reception unit 370, as illustrated in FIG. 16. Differences from the authentication apparatus 300 according to Embodiment 2 will be described below.

When the communication failure information reception unit 370 receives the communication failure information from the mediation apparatus 400, and instructs the additional authentication information verification unit 350 to set a result of the additional authentication as a failure when receiving the communication failure information.

The additional authentication information verification unit 350 obtains the authentication result corresponding to the additional authentication by comparing the registered additional authentication information with the user additional authentication information. However, when being instructed by the communication failure information reception unit 370 to set the additional authentication as the failure, the additional authentication information verification unit 350 sets the authentication result of the additional authentication as the failure.

Other functional configurations are the same as those in Embodiment 2.

### Description of Operation

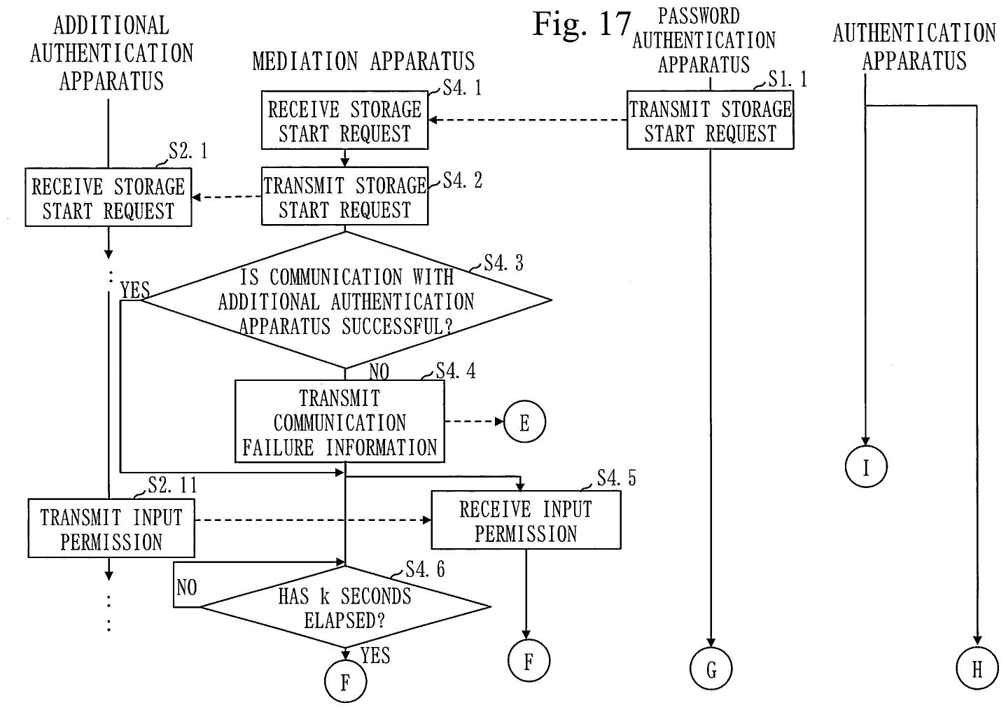

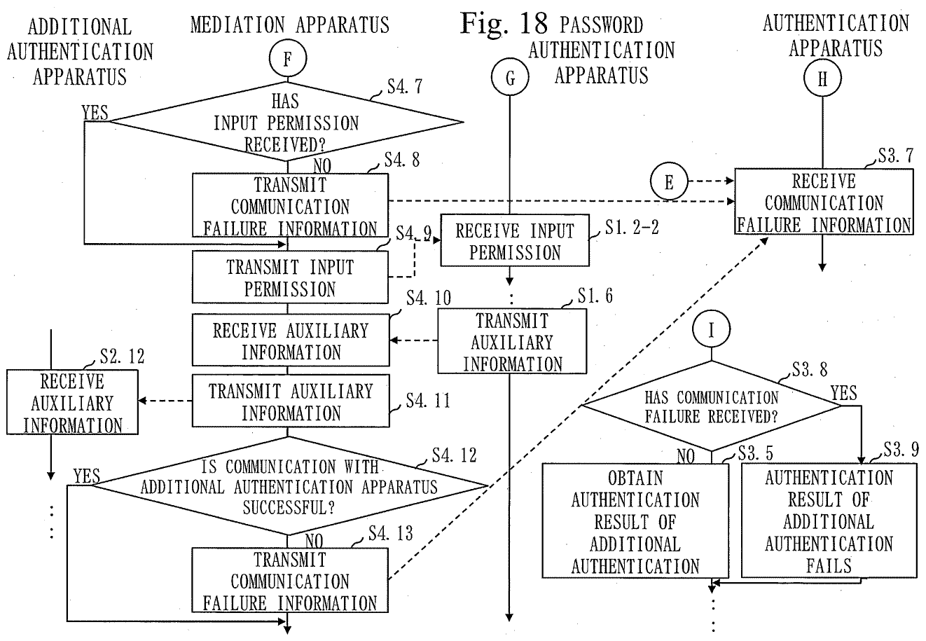

FIGS. 17 and 18 are flowcharts illustrating an operation example of the two-factor authentication system 90 according to Embodiment 3. Differences from Embodiment 2 will be described below with reference to FIGS. 17 and 18.

### (Step S2.1)

The storage start request reception unit 210 receives the data indicating the storage start request.

### (Step S2.11)

The input permission transmission unit 231 transmits the data indicating the input permission to the mediation apparatus 400.

### (Step S2.12)

The auxiliary information reception unit 240 receives the auxiliary information from the mediation apparatus 400.

### (Step S1.1)

The storage start request transmission unit 110 transmits the data indicating the storage start request to the mediation apparatus 400.

### (Step S1.6)

The auxiliary information transmission unit 180 transmits the auxiliary information to the mediation apparatus 400.

### (Step S4.1)

The storage start request reception unit 430 receives the data indicating the storage start request.

### (Step S4.2)

The storage start request transmission unit 440 transmits the data indicating the storage start request to the additional authentication apparatus 200.

### (Step S4.3)

The storage start request transmission unit 440 determines whether or not the communication with the additional authentication apparatus 200 has failed in step S4.2. When the communication with the additional authentication apparatus 200 has failed, the mediation apparatus 400 proceeds to step S4.4. Otherwise, the mediation apparatus 400 proceeds to steps S4.5 and S4.6.

### (Step S4.4)

The communication failure information transmission unit 480 transmits the communication failure information to the authentication apparatus 300.

### (Step S4.5)

The input permission reception unit 450 receives the data indicating the input permission from the additional authentication apparatus 200.

### (Step S4.6)

In parallel with step S4.5, the input request mediation unit 460 waits for k seconds.

### (Step S4.7)

The input request mediation unit 460 determines whether or not the data indicating the input permission has been received in step S4.5. That is, the input request mediation unit 460 determines whether or not the data indicating the input request has been received in step S4.5 while waiting for k seconds in step S4.6. When receiving the data indicating the input request in step S4.5, the mediation apparatus 400 proceeds to step S4.9. Otherwise, the mediation apparatus 400 proceeds to step S4.8.

Here, the reason why the input request mediation unit 460 waits for k seconds is that if the input permission reception unit 450 transmits the data indicating the input permission to the input permission transmission unit 470 immediately after receiving the input permission, the password authentication apparatus 100 that has received the input request knows that the additional authentication apparatus 200 is in a communicable state. That is, regardless of whether the additional authentication apparatus 200 is in the communicable state or not, the wait for k seconds by the input request mediation unit 460 makes it difficult for the password authentication apparatus 100 to grasp the state of the additional authentication apparatus 200.

### (Step S4.8)

The communication failure information transmission unit 480 transmits the communication failure information to the authentication apparatus 300.

### (Step S4.9)

The input permission transmission unit 470 transmits to the password authentication apparatus 100, the data indicating the input permission.

### (Step S4.10)

The auxiliary information reception unit 410 receives the auxiliary information from the password authentication apparatus 100.

### (Step S4.11)

The auxiliary information transmission unit 420 transmits the auxiliary information to the additional authentication apparatus 200.

### (Step S4.12)

The auxiliary information transmission unit 420 determines whether or not the communication with the additional authentication apparatus 200 has failed in step S4.10. When the communication with the additional authentication apparatus 200 has failed, the mediation apparatus 400 proceeds to step S4.13.

### (Step S4.13)

The communication failure information transmission unit 480 transmits the communication failure information to the authentication apparatus 300.

### (Step S3.7)

In parallel with step S3.1, the communication failure information reception unit 370 receives the communication failure information from the mediation apparatus 400.

### (Step S3.8)

The additional authentication information verification unit 350 determines whether or not the communication failure information has been received in step S3.7. When the communication failure information has been received in step S3.7, the authentication apparatus 300 proceeds to step S3.9. Otherwise, the authentication apparatus 300 proceeds to step S3.5.

### (Step S3.9)

The additional authentication information verification unit 350 sets the authentication result corresponding to the additional authentication as a failure.

Other operation examples are the same as those in Embodiment 2.

### Description of Effects of Embodiment 3

As described above, according to the present embodiment, it is possible to implement the two-factor authentication system 90 with higher authentication accuracy while considering privacy by communicating the password authentication apparatus 100 with the additional authentication apparatus 200 via the mediation apparatus 400.

### Other Embodiments

Each of the above described embodiments can be freely combined, or any component of each of the embodiments can be modified. Alternatively, any component can be omitted in each of the embodiments.

Alternatively, the embodiments are not limited to those presented in Embodiments 1 to 3, and various modifications can be made as needed. The procedures described using the flowcharts or the like may be modified as appropriate.

### REFERENCE SIGNS LIST

10: computer; 11: processor; 12: memory; 13: auxiliary storage device; 14: input/output IF; 15: communication device; 18: processing circuit; 19: signal line; 90: two-factor authentication system; 100: password authentication apparatus; 110: storage start request transmission unit; 120: authentication interface display unit; 130: character input acceptance unit; 131: input permission reception unit; 140: password input completion reception unit; 150: password creation unit; 160: password transmission unit; 170: auxiliary information creation unit; 180: auxiliary information transmission unit; 190: input character DB; 200: additional authentication apparatus; 201: sensor; 210: storage start request reception unit; 220: storage suspension request unit; 230: sensor information acquisition unit; 231: input permission transmission unit; 240: auxiliary information reception unit; 250: authentication operation determination unit; 260: transmission request reception unit; 270: determination result acquisition unit; 280: additional authentication information transmission unit; 290: sensor information storage DB; 291: password authentication operation DB; 292: additional authentication information DB; 300: authentication apparatus; 310: password reception unit; 320: password verification unit; 330: transmission request transmission unit; 340: additional authentication information reception unit; 350: additional authentication information verification unit; 360: authentication result determination unit; 370: communication failure information reception unit; 390: password storage DB; 391: additional authentication information DB; 400: mediation apparatus; 410: auxiliary information reception unit; 420: auxiliary information transmission unit; 430: storage start request reception unit; 440: storage start request transmission unit; 450: input permission reception unit; 460: input request mediation unit; 470: input permission transmission unit; 480: communication failure information transmission unit.

1. A two-factor authentication system comprising:
a password authentication apparatus into which a user inputs a subject password; and
an additional authentication apparatus to monitor the password authentication apparatus using a sensor, wherein
the additional authentication apparatus includes processing circuitry, when the number of times of character inputs that the user has inputted the subject password into the password authentication apparatus is not the minimum number of times to input the subject password, to determine whether or not the user has inputted the subject password into the password authentication apparatus based on auxiliary information indicating a work executed by the user to the password authentication apparatus when the user has inputted the subject password, and information acquired by the sensor during a time period when the user has inputted the subject password.

2. The two-factor authentication system according to claim 1, wherein
the auxiliary information includes information indicating each of a work in which the user has executed erroneous input and a work in which the user has corrected the erroneous input.

3. The two-factor authentication system according to claim 1, wherein
when determining whether or not the user has inputted the subject password into the password authentication apparatus, the processing circuitry uses a rule corresponding to a work to be executed when the subject password is inputted into the password authentication apparatus.

4. The two-factor authentication system according to claim 1 further comprising
an authentication apparatus that includes processing circuitry to determine an authentication result corresponding to the subject password inputted into the password authentication apparatus based on the subject password inputted into the password authentication apparatus and a result of determining whether or not the user has inputted the subject password.

5. The two-factor authentication system according to claim 1, wherein
the password authentication apparatus includes
processing circuitry to create the auxiliary information, and
to transmit the created auxiliary information to the additional authentication apparatus.

6. The two-factor authentication system according to claim 1, wherein
when the sensor is activated, the processing circuitry of the additional authentication apparatus transmits to the password authentication apparatus, input permission information indicating that password input is permitted, and
when the input permission information is received from the additional authentication apparatus, the processing circuitry of the password authentication apparatus permits the user to input the subject password.

7. The two-factor authentication system according to claim 1 further comprising
a mediation apparatus to mediate communication between the password authentication apparatus and the additional authentication apparatus, wherein
when the sensor is activated, the processing circuitry of the additional authentication apparatus transmits to the mediation apparatus, input permission information indicating that password input is permitted,
the processing circuitry of the password authentication apparatus
creates the auxiliary information,
transmits the created auxiliary information to the mediation apparatus, and
transmits to the mediation apparatus, storage start request information indicating that the additional authentication apparatus is instructed to monitor the password authentication apparatus,
the mediation apparatus includes:
processing circuitry, when the mediation apparatus has received the input permission information from the additional authentication apparatus at a transmission determination time point which is a time point at which a mediation time or more has elapsed since the mediation apparatus has received the storage start request information from the password authentication apparatus, to transmit the input permission information to the password authentication apparatus; and
to transmit to the additional authentication apparatus, the auxiliary information received from the password authentication apparatus, and
when the input permission information has been received from the mediation apparatus, the processing circuitry of the password authentication apparatus permits the user to input the subject password.

8. A two-factor authentication method in a two-factor authentication system comprising:
by a computer which is an additional authentication apparatus, when the number of times of character inputs that the user has inputted the subject password into a password authentication apparatus is not the minimum number of times to input the subject password, determining whether or not the user has inputted the subject password into the password authentication apparatus based on auxiliary information indicating a work executed by the user to the password authentication apparatus when the user has inputted the subject password, and information acquired by the sensor during a time period when the user has inputted the subject password, wherein
the additional authentication apparatus monitors the password authentication apparatus in which a user inputs a subject password, using a sensor.

9. A non-transitory computer readable medium storing a two-factor authentication program in a two-factor authentication system comprising:
a computer which is a password authentication apparatus in which a user inputs a subject password; and
a computer which is an additional authentication apparatus to monitor the password authentication apparatus using a sensor,
the two-factor authentication program for causing the computer which is the additional authentication apparatus to execute
when the number of times of character inputs that the user has inputted the subject password into the password authentication apparatus is not the minimum number of times to input the subject password, an authentication operation determination process to determine whether or not the user has inputted the subject password into the password authentication apparatus based on auxiliary information indicating a work executed by the user to the password authentication apparatus when the user has inputted the subject password, and information acquired by the sensor during a time period when the user has inputted the subject password.
